(19) United States
(12) Patent Application Publication
(10) Pub. No.: US 2020/0137220 A1
(43) Pub. Date: Apr. 30, 2020

(54) SYSTEM AND METHOD FOR SERVICE DELIVERY

(71) Applicant: COMMSCOPE CONNECTIVITY BELGIUM BVBA, Kessel-Lo (BE)

(72) Inventors: Carsten STORBECK, Stahnsdorf (DE); Jan Jozef DE RIJCK, Kessel-Lo (BE); Vivianne BORTELS, Scherpenheuvel-Zichem (BE)

(21) Appl. No.: 16/493,681

(22) PCT Filed: Mar. 13, 2018
(86) PCT No.: PCT/EP2018/056252

§ 371 Date: Sep. 12, 2019

Related U.S. Application Data
(60) Provisional application No. 62/470,838, filed on Mar. 13, 2017.
(60) Provisional application No. 62/588,072, filed on Nov. 17, 2017.
(60) Provisional application No. 62/634,500, filed on Feb. 23, 2018.

(51) Int. Cl. H04M 3/22; H04M 3/30

(52) U.S. Cl. CPC H04M 3/2245; H04M 2203/056; H04M 3/305; H04M 3/229

(57) ABSTRACT

A system and method for an interruption free copper cable interception and re-routing from an existing service to a new service avoiding transmission effects during the changeover is provided. The system uses a tap line and one or more termination modules to disconnect the existing service before new service is added. Test access is also provided through use of the termination module. Non-active pairs of wires are eliminated during re-routing from an existing service to a new service. Further systems and methods are provided for removing the termination module.

### CROSS-REFERENCE TO RELATED APPLICATIONS

This application claims the benefit of U.S. Patent Application Ser. No. 62/470,838, filed on Mar. 13, 2017, and claims the benefit of U.S. Patent Application Ser. No. 62/588,072, filed on Nov. 17, 2017, and claims the benefit of U.S. Patent Application Ser. No. 62/634,500, filed on Feb. 23, 2018, the disclosures of which are incorporated herein by reference in their entireties.

### BACKGROUND

In telecommunications systems, there is a need to re-route from a legacy (existing) service to a new service with respect to customers who are switching from the legacy service to the new service.

### SUMMARY

A system and method of providing telecommunications service comprising: an interruption free copper cable interception and re-routing from an existing service to a new service avoiding transmission effects during the changeover, including a conductive tap, and a termination module with a disconnection plug.

Testing of the new service pathways is also provided through the termination module.

A system and method of providing telecommunications service is provided wherein non-active pairs of wires are eliminated during re-routing from an existing service to a new service.

Another system and method allows for testing of the new service.

Further systems and methods are provided for removing the termination module in an effort to save space, if desired.

### BRIEF DESCRIPTION OF THE DRAWINGS

FIG. 1 is a schematic view showing a system and method for switching between legacy service and new service;

FIG. 2 is a schematic representation of a termination block or module shown in the system of FIG. 1;

FIG. 3 is a schematic representation of a disconnection contact of the termination block or module of FIG. 2, shown in a normally-closed state;

FIG. 4 is a schematic representation of the disconnection contact of FIG. 3, shown in an open state;

FIGS. 5-7 relate to schematics of systems and methods for locating active wires, and then connecting a new service to the active wires; wherein FIG. 5 shows an existing service including a termination module for use in testing for active service, FIG. 6 shows the disconnection of the existing service to a new service through the termination module, and FIG. 7 shows connection of the new service directly to the customer or subscriber without the presence of the termination module;

FIGS. 8-11 and 11 A are similar representations of the systems and methods shown in FIGS. 5-7, wherein a termination module is utilized for testing and connection, wherein an existing service is tested (FIG. 8), active wire pairs are connected to a new service (FIGS. 8A, 8B, 8C, 9), the existing service is removed (FIG. 10) and, the termination module can be removed at the conclusion of the testing and connection to the new service (FIGS. 11 and 11A); and

FIGS. 12-20 show an example cabling system and method showing actual cables and termination modules, shown schematically in FIGS. 5-7 and FIGS. 8-11A.

### DETAILED DESCRIPTION

A system 10 and a related process for an interruption free copper cable interception and re-routing from a legacy (existing) service to a new service is provided. The system 10 avoids transmission effects during a change over. In the current or existing state, the signal flow goes via a copper multi-pair OSP (outside plant) cable from the legacy service side 20 to the subscriber or customer 30 over pathways 1 and 2. The signal is carried on cable 22 including portion 22a and 22b. Typically, pathways 1 and 2 are the same cable and are not interrupted at area D. Legacy service is delivered in the direction of arrows 24.

When new service is desired, on a point on the existing copper cable 22, an access to the buried or overhead copper cable needs to be provided by taking the outer insulation off or otherwise piercing the jacket of the cable to gain access to the individual copper cables of the multi-pair cable. Preferably, the access is selectable from a variety of access option. These individual selectable copper cables will be parallel and interruption free electrically connected to a single line connector B which provides three electrical access points on the same electrical potential. A PICABOND™ connector, by CommScope, Inc. is one example of a device to add a tap line by splicing to a conductor of a multi-conductor telephone cable.

The two electrical connections 4 are now electrically replacing the old line through connection pathway 1 along pathway 2 on conductor 22b. The third leg 5 of the single line connector B will be terminated with another individual copper cable 5 which provides a connection to the electrical connector A. An example of connector A is an LSA plus™ termination module. The termination module may also be referred to as a disconnect module.

This procedure can be repeated for multiple amounts of copper cables up to the maximum capacity of the legacy multi-pair OSP cable. The electrical connector A is constructed in a way that two connection points for one individual copper cable are isolated against each other by using a disconnection element C which electrically isolates both termination sides. This disconnection element C can be designed as an individual or a multi-pair isolating element. The cable side 3 of the electrical connector A is already pre-cabled to the new service device.

With this type of cable arrangement, an interruption free method of individual copper pair access and re-routing to a new service device has been realized, but not put in final electrical connection from the new service to the customer home due to the isolating function of the disconnection element C. Besides the blocking of the new service signal, this disconnection element C is also blocking electrical interferences from the new copper cables to the legacy copper multi-pair OSP cables still carrying the legacy service. Once the disconnection element C is removed and the legacy service cut, the new service is delivered in the direction of arrows 44.

In addition, the disconnection element C can be used for electrical copper line tests using the 2 pole method or the 4 pole method. The 2 pole method uses a test plug in the disconnect module that looks only at one pair of wires (in one direction). The 4 pole method uses a test plug in the disconnect module that looks at both pairs of wires (in both directions).

During the transition time of this described procedure the electrical connector arrangements B and A will be integrated in an enclosure D which allows access multiple times together with a sealed protection against environmental influence. Once individual copper cables for new service activation are identified and terminated with the above described method, the final service activation can be carried out by physically cutting the re-routed copper cables at the legacy service multi-pair OSP copper cable 6. Afterwards, the disconnection element C will be taken out of the connector A. As a result, a new electrical connection has been made from the new service point to the customer's home. The enclosure D can be changed over on request on a kind of heat-shrinkable closure device for final and commercial efficient environmental protection in a buried or over-head type of copper cable structure.

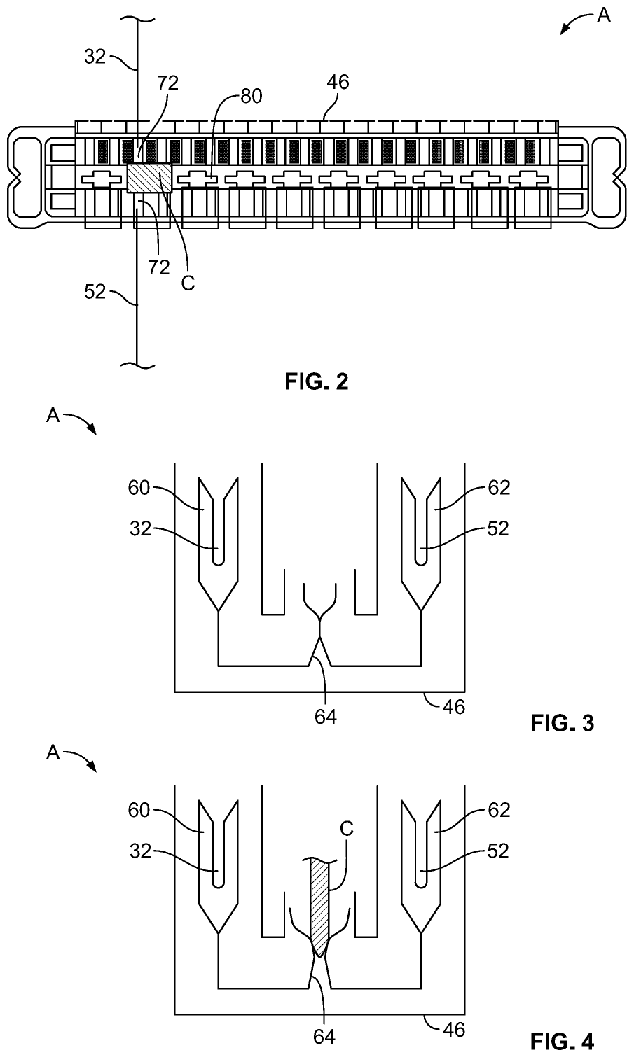

The system 10 of FIGS. 2-4 generally includes a termination block or module 46. In the illustrated system 10, the termination module 46 is configured to selectively route the signal to and from the new service 40.

Referring to FIGS. 2-4, to provide new service to a particular subscriber, a service technician accesses a dedicated site 72 of the terminating module 46. The dedicated site 72 is a particular site or connection location of the termination module 46 that is dedicated to the particular subscriber. The technician re-routes the telephone signal at that dedicated site 72 of the termination module 46 to the customer 30.

Referring to FIGS. 2-4, the terminating module 46 includes a plurality of block sites 72. To prevent new service for the subscriber 30, the termination module 46 is configured so that a signal path from the incoming block or module line 52 to the distribution line 32 is disrupted by plug C. Plug C fits into opening 80. Plug C disconnects the disconnection contact 64 of termination module 46.

Referring to FIGS. 2-4, in the illustrated embodiment, the termination module 46 is an insulation displacement connection (IDC) block. Unlike blocks that rely on screw-terminals or a wire wrapping technique to secure wires to the block, IDC blocks provide for a gas-tight connection without requiring the removal of insulation covering the wire. Connection is achieved once a wire is placed into an IDC block contact, and then punched down, typically via an insertion tool that presses the wire against the contact to form the gas-tight connection. Because of the ease of use and effectiveness, termination blocks utilizing IDC contacts 60, 62 have become the standard within the telecommunications industry.

To modify the termination module 46 and activate the new service (i.e., disrupt the first signal path), the technician can easily activate and de-activate the new service to the subscriber 40 simply by inserting and removing the activation plug C into and from the termination module 46. Details of the function and operation of another system including a termination module are shown a described in U.S. patent application Ser. No. 10/301,960 (U.S. Pat. No. 7,155,004) and Ser. No. 10/725,108 (U.S. Pat. No. 7,409,053); which applications are incorporated herein by reference. The termination module may also be referred to as a Krone style multiple contact pair block, one specific example being the LSA plus™ block noted above, from Krone GmbH, ADC GmbH, TE Connectivity, or CommScope, Inc. In general, with the systems and methods herein legacy service is provided at day 1. At day 2, a tap line can be added. The tap line is electrically connected (with a disconnection contact in the open or disconnected state) to the new service. Then the legacy service is cut or disrupted, and then the disconnection contact is placed in the closed or connected state, wherein new service is provided.

The connections described herein are made wire by wire. An advantageous aspect is to test whether a pair of wires is active. This can only be done when one can measure between the two wires of a pair. The wire pairs are labeled with the wires as 1a, 1b (pair 1), 2a, 2b (pair 2), etc. (European style) or in the US: 1T, 1R (pair 1), 2T, 2R (pair 2), etc. (for Tip and Ring).

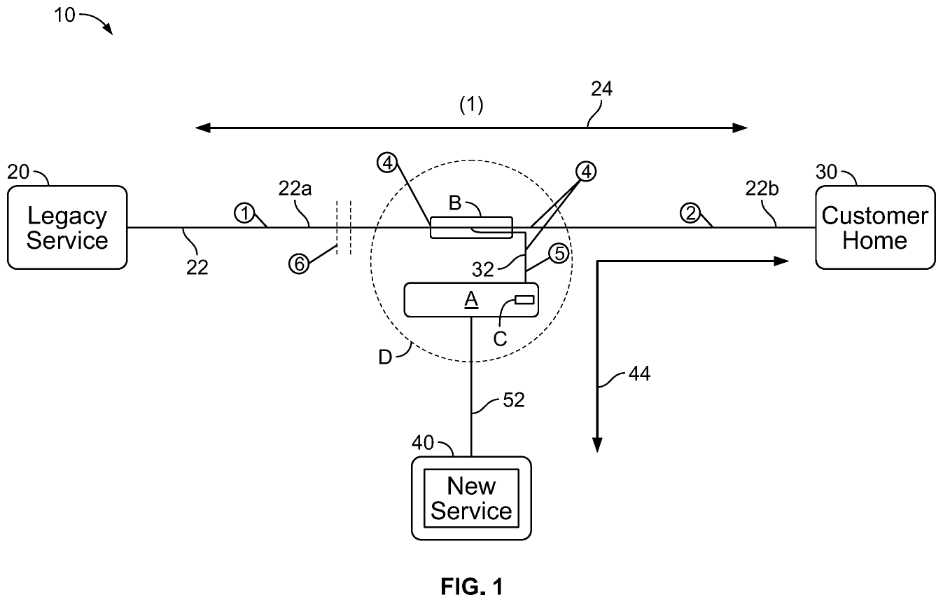

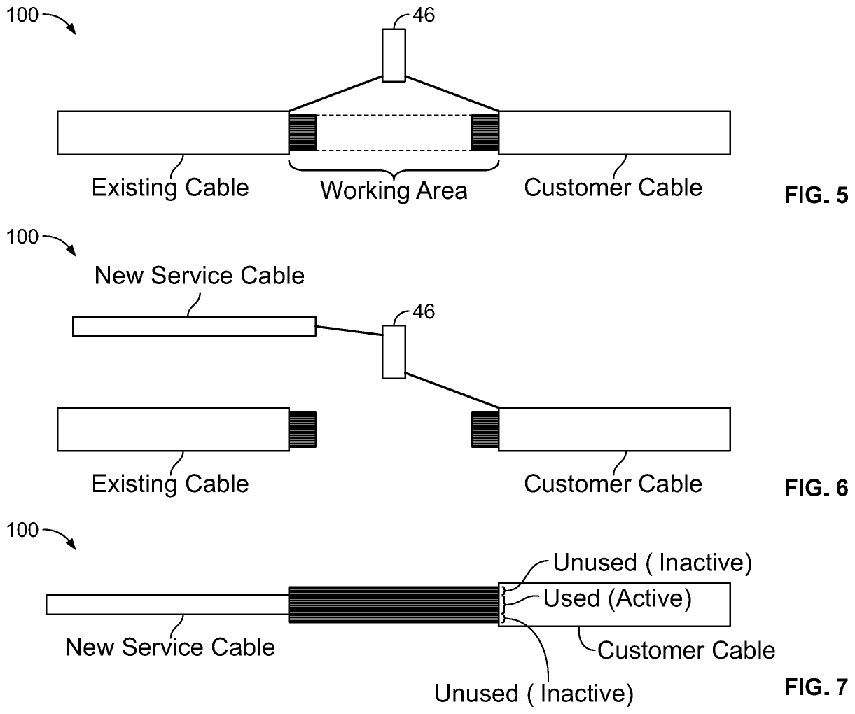

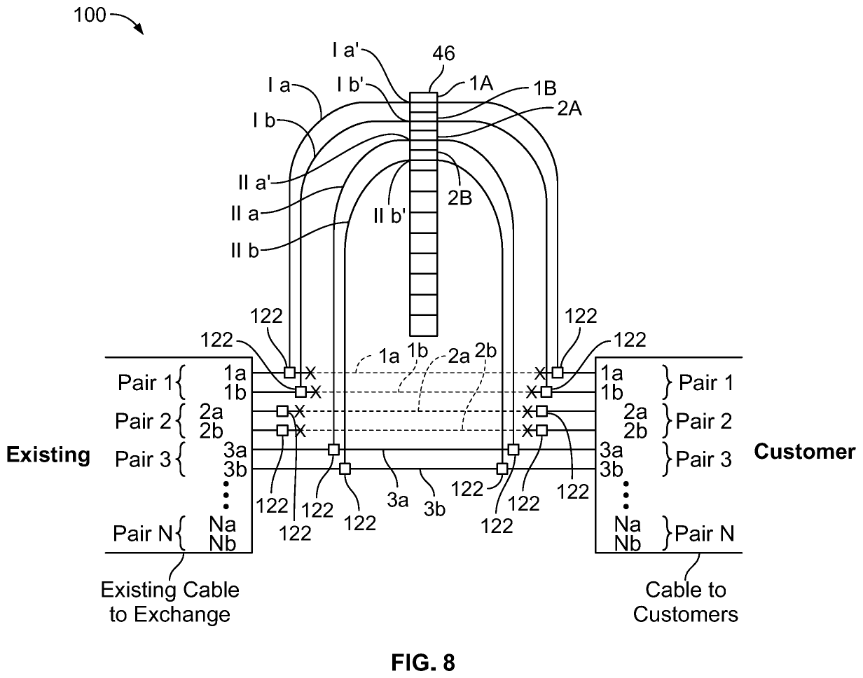

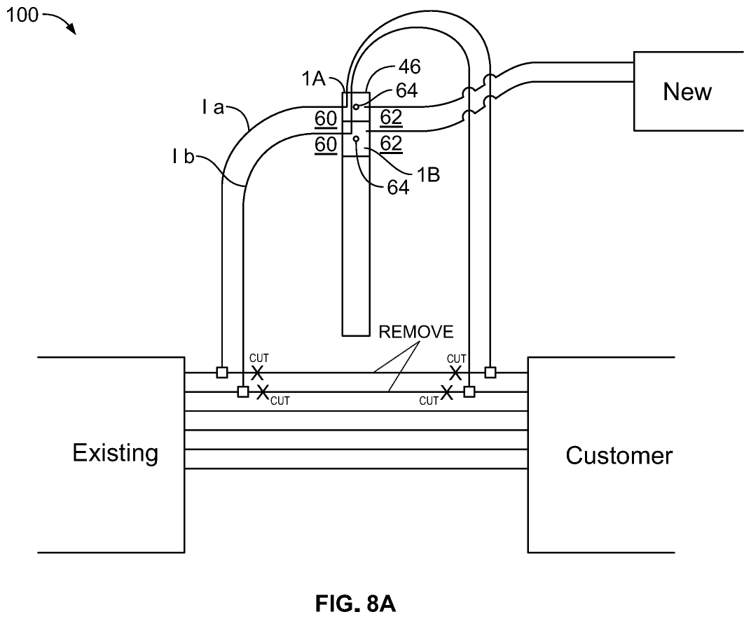

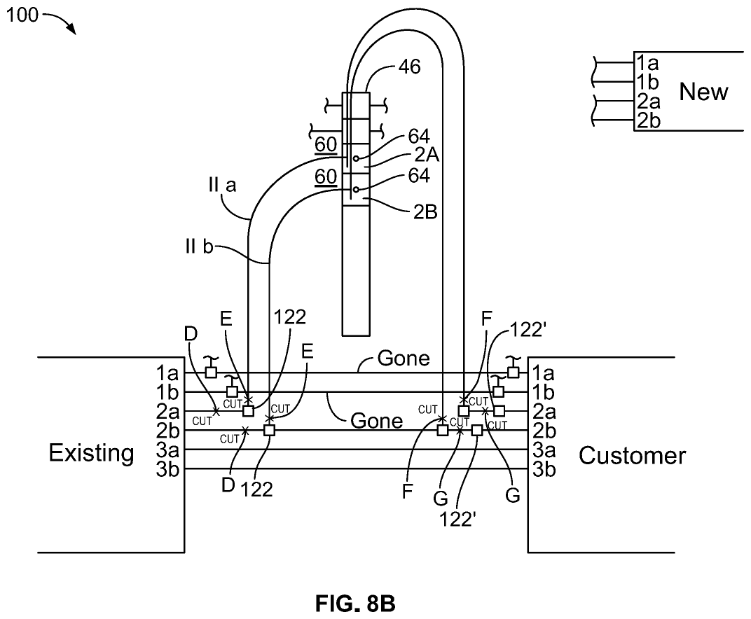

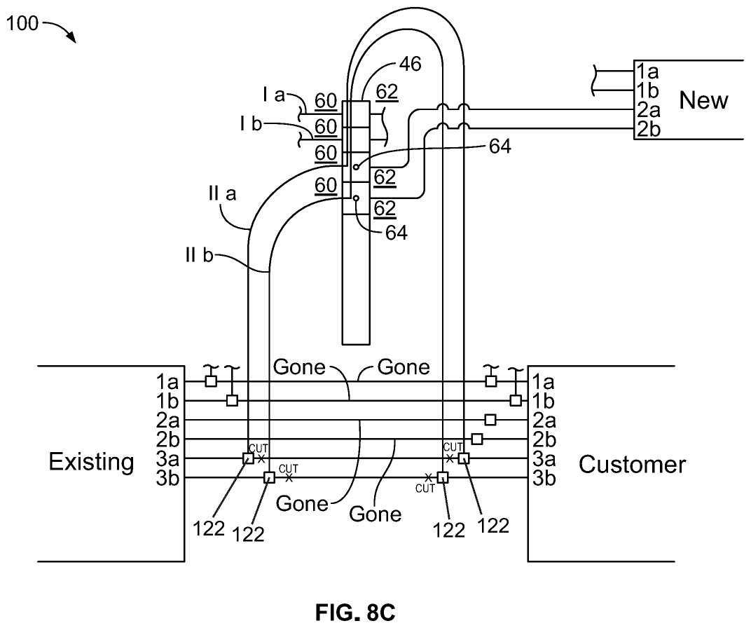

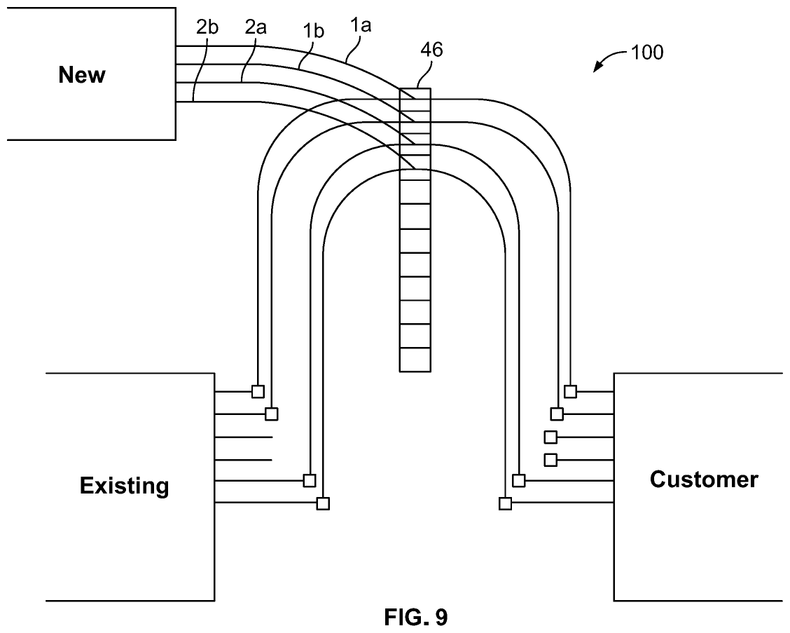

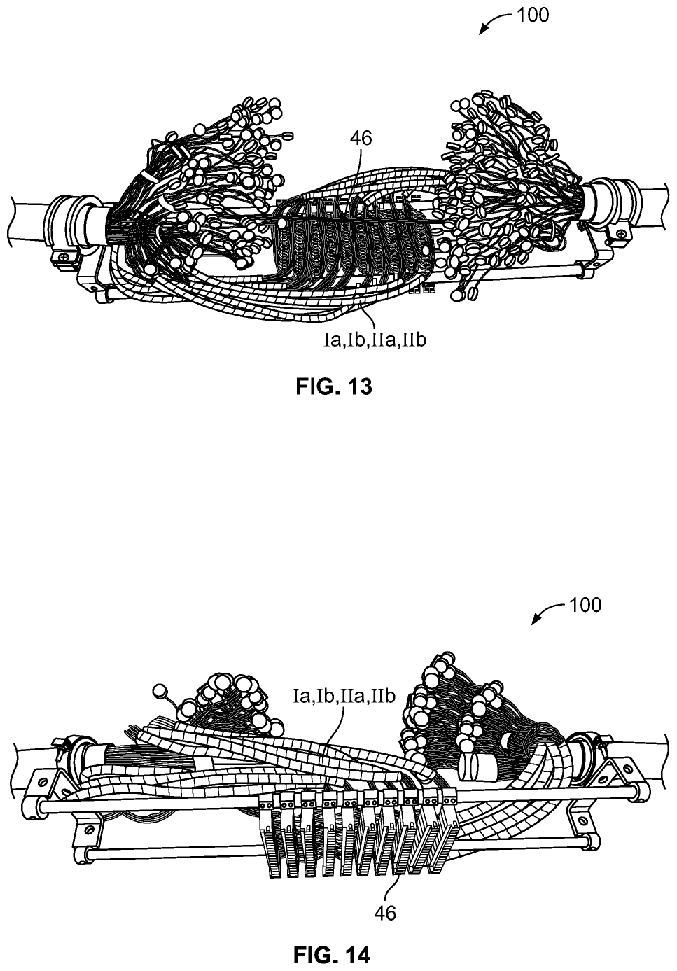

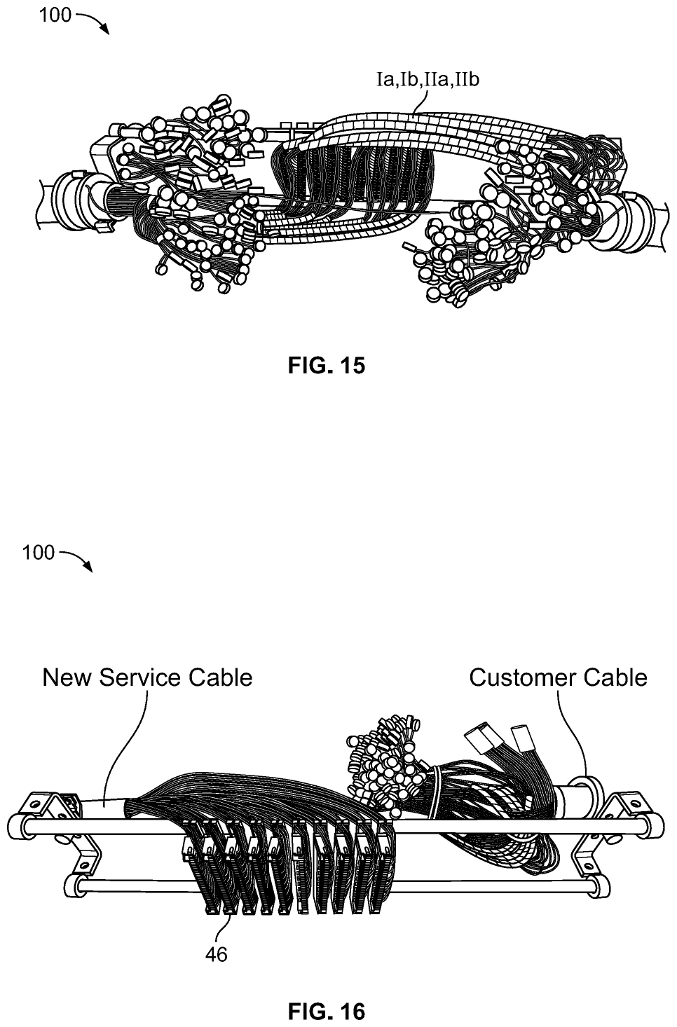

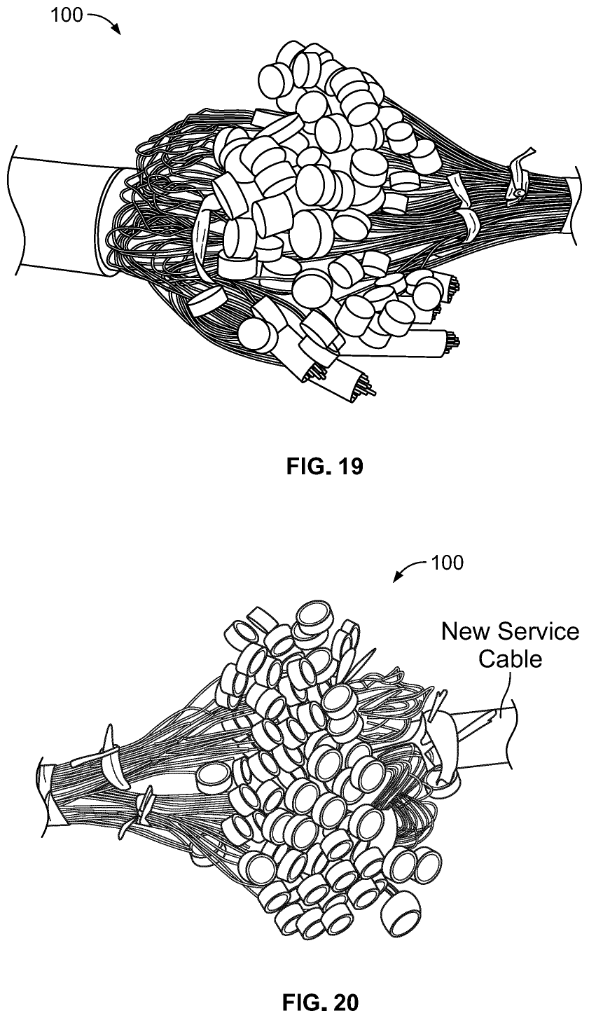

A related system and method is shown in FIGS. 5-20 to the system and method of FIGS. 1-4. The system 10 of FIGS. 1-4 utilizes single half taps B for each wire. An alternate system 100 and related method is provided as shown in FIGS. 5-20 and described below. The alternate system 100 is results in the removal of existing or legacy service and a cut over to new service.

System 100 may offer advantages such as allowing for more working room for the technician doing the cut over. Other advantages include locating and eliminating unused wire pairs from the cut over, saving time and/or storage space for the wire connection structure. Some aspects of system 100 are advantageous in that the final cut over may allow a test function. Other aspects of system 100 are advantageous in that the final cut over may allow for reduced storage needs for the wire connection structure if the test function is removed at the conclusion of the cutover.

Half taps 122 like connectors B above are used in system 100, as well as one or more of blocks or termination modules 46 as described above and shown in FIGS. 2-4.
One Example procedure is:
I. Test pair I at block or module 46:
   Add a wire (Ia) with two half taps 122 in parallel to wire 1a. This parallel wire is going through the IDC connector 1a at port 1A of the block (IDC 60).
   Add a wire (Ib) with two half taps 122 in parallel to wire 1b. This parallel wire is going through the IDC connector 1b at port 1B of the block.
   Test whether pair 1 is active by measuring between the contacts Ia′ and Ib′ on the block. This is done by inserting a test plug in the disconnect slot 64 of the block.
      A. If active, remove the original wires 1a and 1b between the half taps 122.
      B. If not active, see below II.B.
II. Test pair 2 at block:
   Add a wire (IIa) with two half taps 122 in parallel to wire 2a. This parallel wire is going through the IDC connector IIa′ at port 2A of the block.
   Add a wire (IIb) with two half taps 122 in parallel to wire 2b. This parallel wire is going through the IDC connector IIb′ at port 2B of the block.
   Test whether pair 2 is active by measuring between the contacts IIa′ and IIb′ on the block. This is done by inserting a test plug in the disconnect slot 64 of the block.
   A. If active, remove the original wires 2a and 2b between the half taps.
   B. If not active, cut wires 2a, 2b, IIa and IIb at D, E, F, G. Optionally add clear caps 122′ at D & G.
III. Test pair 3 at block, under assumption that pair 2 was not active:
   Add a wire (IIa) with two half taps 122 in parallel to wire 3a. This parallel wire is going through the IDC connector IIa′ of the block.
   Add a wire (IIb) with two half taps 122 in parallel to wire 3b. This parallel wire is going through the IDC connector IIb′ of the block.
   Test whether pair 3 is active by measuring between the contacts IIa′ and IIb′ on the block. This is done by inserting a test plug in the disconnect slot 64 of the block.
      A. If active, remove the original wires 3a and 3b between the half taps.
      B. If not active, see II.B

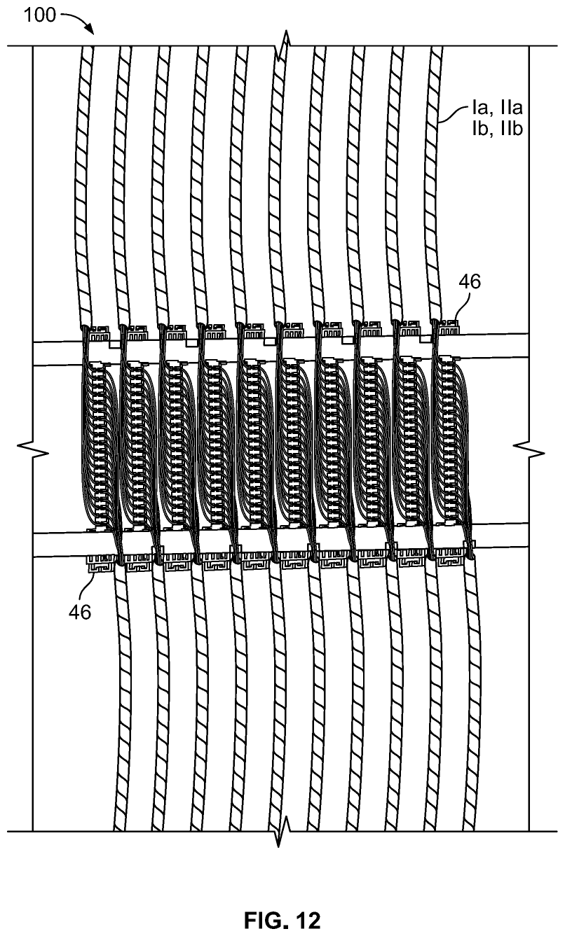

See also FIGS. 12-15 showing various steps in the testing and cable preparation.

When all active pairs are connected to the block or blocks, first insert insulating plugs in all the disconnect slots 64 of the blocks. This to ensure that no stub (bridge tap) is seen on the pair when the cable with the new service is connected to the other side of the blocks (IDC 64).

Connect the cable with the pairs that carry the new service to the other side of the blocks. This can be done at a later time.

Optionally test the new service at the block. This can be done by inserting a test plug in the disconnect slot and connecting a handheld tester to the pair that carries the new service. If the new service on block position I is ok, cut the wires Ia and Ib at the exchange side of the block. Then remove the test plug or insulating plug. Repeat for each position on the blocks.

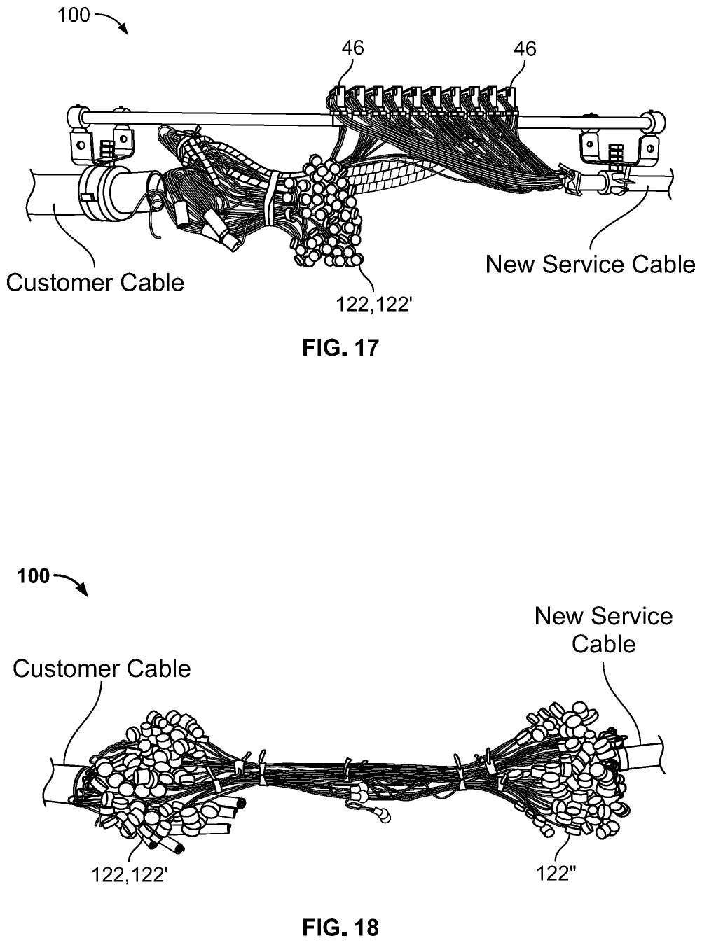

When all active pairs are connected to the new service, the cable going back to the exchange can be removed. See FIGS. 16 and 17.

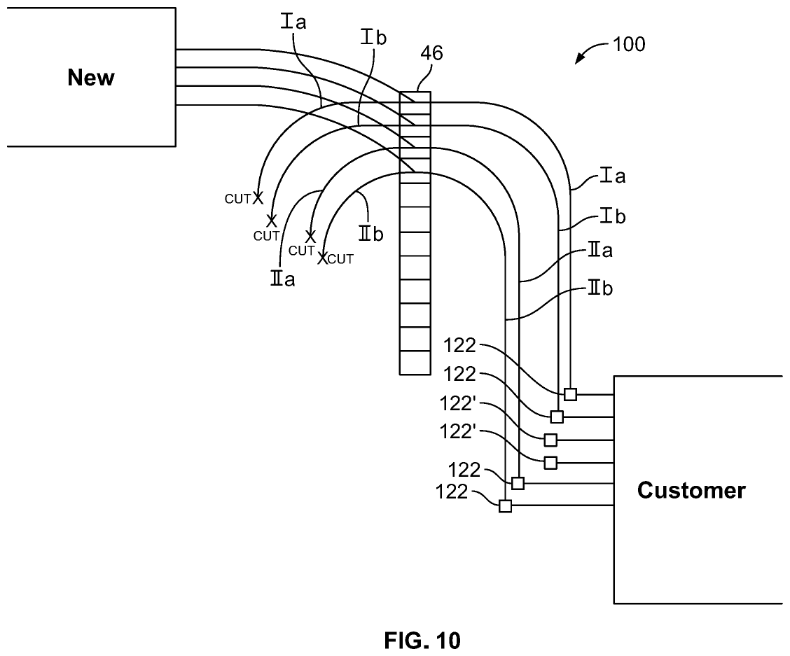

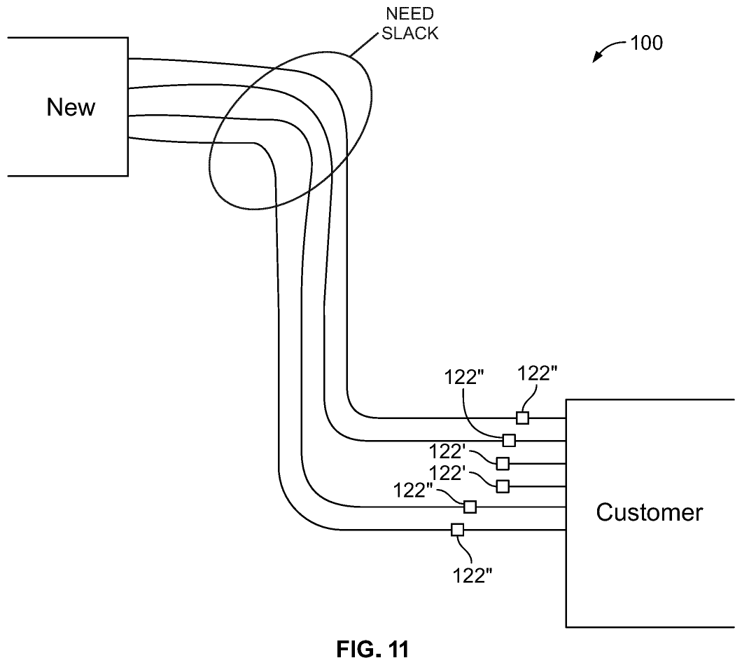

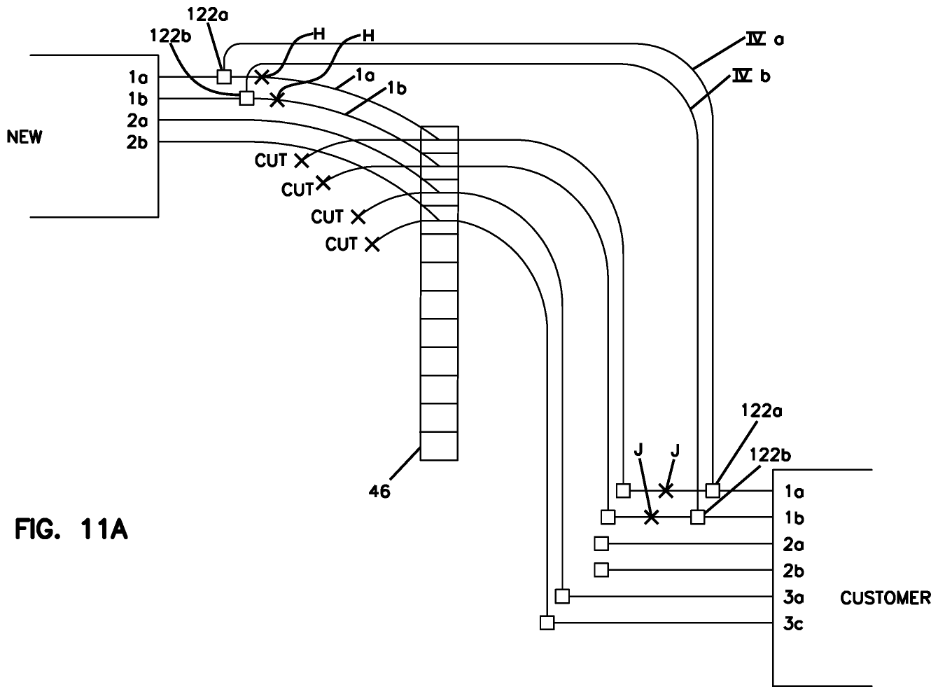

Three alternatives:
1. The blocks remain in place: advantage is that there is a test access point in the closure that will enclose the cables and blocks. Disadvantage is that it requires more space. See FIGS. 10, 16 and 17.
2. The blocks are removed and a direct connection with a connector 122″ is made between the pairs carrying the new service and the active pairs in the cable going to the customers. Advantage: requires less space for the final enclosure. Disadvantage: will cause a short service interruption and no test access point anymore. See FIGS. 11 and 18-20.
3. The blocks are removed without a loss of service. A direct connection with new wires IVa, IVb each with two half taps 122a, 122b is provided. Once the direct connection is provided, cut wires 1a, 1b of the new service at H, and cut the customer wires 1a, 1b at J. Repeat for all the active pairs of the customer cable. This results in no service interruption. This also requires less space for the final enclosure as in option 2. See FIGS. 11A, and 18-20.

1. A method of providing telecommunications service comprising:
providing a signal service pathway from a first service source to a subscriber location, wherein the signal service pathway includes a first copper signal pathway including at least one pair of twisted copper wires;
accessing at least one of the pairs of wires, and adding a conductive tap line to each wire;
terminating the conductive tap lines at a termination module with a normally closed configuration, wherein the normally closed configuration includes a normally closed contact set, wherein a disconnection plug holds open the normally closed contact set;
terminating a second copper signal pathway including at least one pair of twisted copper wires at the termination module;
cutting or otherwise disrupting the signal service pathway at a location between the first service source and the conductive tap line;
after the signal service pathway is cut, removing the disconnection plug, wherein the second copper signal pathway is connected to the first signal service pathway and to the subscriber location.

2. A system of providing telecommunications service comprising:
a signal service pathway from a first service source to a subscriber location, wherein the signal service pathway includes a first copper signal pathway including at least one pair of twisted copper wires;
a conductive tap line to each wire;
the conductive tap lines terminated at a termination module with a normally closed configuration, wherein the normally closed configuration includes a normally closed contact set, wherein a disconnection plug holds open the normally closed contact set;
a second copper signal pathway including at least one pair of twisted copper wires terminated at the termination module;
wherein the second copper signal pathway is connectable to the first signal service pathway and to the subscriber location through the termination module after the signal service pathway is cut and after the disconnection plug is removed.

3. (canceled)

4. The system of claim 2, wherein the cables are 4 pair, twisted wire pair cables.

5. The system of claim 2, wherein the termination module is a Krone style multiple contact pair block.

6. A method of providing telecommunications service comprising:
providing a signal service pathway from a first service source to a subscriber location, wherein the signal service pathway includes a first copper signal pathway including at least one pair of twisted copper wires;
accessing at least one of the pairs of wires, and adding two conductive tap lines to each wire;
terminating the conductive tap lines at a termination module with a normally closed configuration, wherein the normally closed configuration includes a normally closed contact set;
after locating selected pairs of wires, terminating a second copper signal pathway including at least one pair of twisted copper wires at the termination module;
cutting or otherwise disrupting the signal service pathway at a location between the first service source and the conductive tap line; wherein the second copper signal pathway is connected to the first signal service pathway and to the subscriber location, wherein locating selected pairs of wires includes:
I. Testing pair 1 at the block or module 46:
Add a wire (Ia) with two half taps 122 in parallel to wire 1a. This parallel wire is going through the IDC connector la at port 1A of the block.
Add a wire (Ib) with two half taps 122 in parallel to wire 1b. This parallel wire is going through the IDC connector 1b at port 1B of the block.
Test whether pair 1 is active by measuring between the contacts Ia′ and Ib′ on the block. This is done by inserting a test plug in the disconnect slot 64 of the block.
A. If active, remove the original wires 1a and 1b between the half taps 122.
B. If not active, see below II.B.
II. Testing pair 2 at the block:
Add a wire (IIa) with two half taps 122 in parallel to wire 2a. This parallel wire is going through the IDC connector IIa′ at port 2A of the block.
Add a wire (IIb) with two half taps 122 in parallel to wire 2b. This parallel wire is going through the IDC connector IIb′ at port 2B of the block.
Test whether pair 2 is active by measuring between the contacts IIa′ and IIb′ on the block. This is done by inserting a test plug in the disconnect slot 64 of the block.
A. If active, remove the original wires 2a and 2b between the half taps.
B. If not active, cut wires 2a, 2b, IIa and IIb at D, E, F, G. Optionally add clear caps 122′ at D & G.
III. Test pair 3 at the block, under assumption that pair 2 was not active:
Add a wire (IIa) with two half taps 122 in parallel to wire 3a. This parallel wire is going through the IDC connector IIa′ of the block.
Add a wire (IIb) with two half taps 122 in parallel to wire 3b. This parallel wire is going through the IDC connector IIb′ of the block.
Test whether pair 3 is active by measuring between the contacts IIa′ and IIb′ on the block. This is done by inserting a test plug in the disconnect slot 64 of the block.
A. If active, remove the original wires 3a and 3b between the half taps.
B. If not active, see II.B

7. The method of claim 6, wherein when all active pairs are connected to the block or blocks, first insert insulating plugs in all the disconnect slots of the blocks.

8. The method of claim 6, connecting the cable with the pairs that carry the new service to the other side of the blocks.

9. The method of claim 6, testing the new service at the block, by inserting a test plug in the disconnect slot and connecting a tester to the pair that carries the new service, wherein if the new service on block position I is ok, cut the wires Ia and Ib at the exchange side of the block. Then remove the test plug or insulating plug, and repeat for each position on the blocks.

10. The method of claim 6, wherein when all active pairs are connected to the new service, the cable going back to the exchange is removed.

11. The method of claim 10, wherein the blocks remain in place.

12. The method of claim 10, wherein the blocks are removed and a direct connection with a connector 122″ is made between the pairs carrying the new service and the active pairs in the cable going to the customers.

13. The method of claim 10, wherein a direct connection is made between the pairs carrying the new service and the active pairs in the cable going to the customers before removing the blocks using new wires and new half taps.
